(19) United States
(12) Patent Application Publication
(10) Pub. No.: US 2026/0327003 A1
(43) Pub. Date: Oct. 22, 2026

(54) REFUSE COLLECTION VEHICLES WITH BATTERY CHARGING SYSTEMS

(71) Applicant: The Heil Co., Chattanooga, TN (US)

(72) Inventors: Jonathan Paul Shadrick, Trenton, GA (US); Tony Lawayne Coffey, Dawson, AL (US); Chankit Jain, Fort Payne, AL (US)

(21) Appl. No.: 19/468,380

(22) Filed: Feb. 3, 2026

Related U.S. Application Data
(60) Provisional application No. 63/753,575, filed on Feb. 4, 2025.

(51) Int. Cl. B65F 3/14; B60L 1/00; B60L 50/60; B65F 3/02

(52) U.S. Cl. CPC B65F 3/14; B60L 1/00; B60L 50/60; B60L 2210/10; B60L 2240/12; B65F 2003/023

(57) ABSTRACT

A refuse collection vehicle includes a wheeled chassis with an electric propulsion motor connected to a road wheel of the chassis; a chassis battery configured to provide electrical power to the electric propulsion motor; a refuse collection body carried by the wheeled chassis and defining a refuse storage compartment, the refuse collection body comprising one or more body components; a body battery configured to provide electrical power to the one or more body components; a battery charger connected to the chassis battery and configured to charge the body battery from the chassis battery; and at least one processor configured to perform operations comprising controlling the battery charger to charge the body battery from the chassis battery when one or more body battery charging criteria are satisfied.

### CROSS-REFERENCE TO RELATED APPLICATION

This application claims the benefit of U.S. Provisional Patent Application No. 63/753,575, filed on Feb. 4, 2025, the contents of which are incorporated herein by reference in its entirety.

### TECHNICAL FIELD

This disclosure relates to refuse collection vehicles, and more particularly to electric refuse collection vehicles.

### BACKGROUND

Refuse collection vehicles collect solid waste and transport the solid waste to landfills, recycling centers, or treatment facilities. Refuse collection vehicles powered with fossil fuels can have low fuel efficiency and/or emit relatively high amounts of carbon emissions. Additionally, most refuse collection vehicles use hydraulic systems, some of which require extensive maintenance, are noisy, consume power at idle, and leak. Methods and equipment for improving electric refuse collection vehicles are sought.

Implementations of the present disclosure include a refuse collection vehicle. The refuse collection vehicle includes a wheeled chassis with an electric propulsion motor connected to a road wheel of the chassis; a chassis battery configured to provide electrical power to the electric propulsion motor; a refuse collection body carried by the wheeled chassis and defining a refuse storage compartment, the refuse collection body including one or more body components; a body battery configured to provide electrical power to the one or more body components; a battery charger connected to the chassis battery and configured to charge the body battery from the chassis battery; and at least one processor configured to perform operations including controlling the battery charger to charge the body battery from the chassis battery when one or more body battery charging criteria are satisfied.

In some implementations, charging the body battery from the chassis battery when one or more body battery charging criteria are satisfied includes charging the body battery in between refuse pickup events performed by the vehicle.

In some implementations, charging the body battery from the chassis battery when the one or more body battery charging criteria are satisfied includes charging the body battery when electric current drawn from the body battery is at or below a threshold electric current.

In some implementations, controlling the battery charger to charge the body battery from the chassis battery when the one or more body battery charging criteria are satisfied includes: obtaining a battery charge level of the body battery; determining that the battery charge level of the body battery satisfies first battery charging criteria; obtaining operational sensor data indicating a condition of the refuse collection vehicle; determining, based on the operational sensor data, that the condition of the refuse collection vehicle satisfies second battery charging criteria; and in response to determining that (i) the battery charge level of the body battery satisfies the first battery charging criteria and (ii) the condition of the refuse collection vehicle satisfies the second battery charging criteria, initiating charging of the body battery from the chassis battery.

In some implementations, the operations include: after initiating charging the body battery, determining that a refuse pickup event is beginning, and in response, stopping charging of the body battery.

In some implementations, controlling the battery charger to charge the body battery from the chassis battery includes: after initiating charging of the body battery from the chassis battery, determining that the battery charge level of the body battery satisfies stop criteria for stopping charging of the body battery; and in response, stopping charging of the body battery from the chassis battery.

In some implementations, the stop criteria includes the battery charge level being at or above a threshold charge level.

In some implementations, the first battery charging criteria includes a threshold battery charge level.

In some implementations, the operations including: determining, using the operational sensor data, that a refuse pickup event has been completed, and in response, initiating charging the body battery.

In some implementations, the operational sensor data includes sensor data indicating a speed of the refuse collection vehicle.

In some implementations, the second battery charging criteria includes a threshold vehicle speed.

In some implementations, the operational sensor data includes sensor data indicating an operational state of the one or more body components.

In some implementations, the one or more body components include a lift arm, and the second battery charging criteria includes a position of the lift arm.

In some implementations, the one or more body components include a refuse packer, and the second battery charging criteria includes a position of the refuse packer.

In some implementations, controlling the battery charger to charge the body battery from the chassis battery includes: after initiating charging of the body battery from the chassis battery, obtaining updated operational sensor data indicating an updated condition of the refuse collection vehicle; determining, based on the updated operational sensor data, that the updated condition of the refuse collection vehicle does not satisfy the second battery charging criteria; and in response, stopping charging of the body battery from the chassis battery.

In some implementations, the body components include a refuse packer driven by an electric packer actuator, and the operational sensor data indicates a position of the refuse packer.

In some implementations, the body components include powered tailgate driven by an electric tailgate actuator, and the operational sensor data indicates a position of the tailgate.

In some implementations, the body components include a lift arm driven by an electric lift arm motor, and the operational sensor data indicates a position of a lift arm. The lift arm is configured to lift a refuse container and empty the refuse container into the refuse storage compartment.

In some implementations, the battery charger includes a DC-DC converter.

In some implementations, controlling the battery charger includes controlling a rate of charge of the body battery.

In some implementations, the battery charger is configured to receive electricity from the chassis battery at a voltage of between 500 Volts (V) to 1000V and output electricity at a voltage of less than between 90V and 120V.

In some implementations, the body components are driven by electric motors powered by the body battery.

In some implementations, the vehicle further includes a power distribution unit configured to receive electricity from the body battery and distribute the electricity to the body components.

Implementations of the present disclosure include a method of operating a refuse collection vehicle, including: controlling, by at least one processor, a battery charger to charge a body battery of the refuse collection vehicle from a chassis battery of the refuse collection vehicle when one or more body battery charging criteria are satisfied. The chassis battery is configured to provide electrical power to an electric propulsion motor connected to a road wheel of a chassis of the refuse collection vehicle, and the body battery is configured to provide electrical power to one or more body components of a refuse collection body that defines a refuse storage compartment and is carried by the chassis.

In some implementations, charging the body battery from the chassis battery when one or more body battery charging criteria are satisfied includes charging the body battery in between refuse pickup events performed by the vehicle.

In some implementations, charging the body battery from the chassis battery when the one or more body battery charging criteria are satisfied includes charging the body battery when electric current drawn from the body battery is at or below a threshold electric current.

In some implementations, controlling the battery charger to charge the body battery from the chassis battery when the one or more body battery charging criteria are satisfied includes: obtaining a battery charge level of the body battery; determining that the battery charge level of the body battery satisfies first battery charging criteria; obtaining operational sensor data indicating a condition of the refuse collection vehicle; determining, based on the operational sensor data, that the condition of the refuse collection vehicle satisfies second battery charging criteria; and in response to determining that (i) the battery charge level of the body battery satisfies the first battery charging criteria and (ii) the condition of the refuse collection vehicle satisfies the second battery charging criteria, initiating charging of the body battery from the chassis battery.

In some implementations, the method includes: after initiating charging the body battery, determining that a refuse pickup event is beginning, and in response, stopping charging of the body battery.

In some implementations, controlling the battery charger to charge the body battery from the chassis battery includes: after initiating charging of the body battery from the chassis battery, determining that the battery charge level of the body battery satisfies stop criteria for stopping charging of the body battery; and in response, stopping charging of the body battery from the chassis battery.

In some implementations, the stop criteria includes the battery charge level being at or above a threshold charge level.

In some implementations, the first battery charging criteria includes a threshold battery charge level.

In some implementations, the method includes: determining, using the operational sensor data, that a refuse pickup event has been completed, and in response, initiating charging the body battery.

In some implementations, the operational sensor data includes sensor data indicating a speed of the refuse collection vehicle.

In some implementations, the second battery charging criteria includes a threshold vehicle speed.

In some implementations, the operational sensor data includes sensor data indicating an operational state of the one or more body components.

In some implementations, the one or more body components include a lift arm, and the second battery charging criteria includes a position of the lift arm.

In some implementations, the one or more body components include a refuse packer, and the second battery charging criteria includes a position of the refuse packer.

In some implementations, controlling the battery charger to charge the body battery from the chassis battery includes: after initiating charging of the body battery from the chassis battery, obtaining updated operational sensor data indicating an updated condition of the refuse collection vehicle; determining, based on the updated operational sensor data, that the updated condition of the refuse collection vehicle does not satisfy the second battery charging criteria; and in response, stopping charging of the body battery from the chassis battery.

In some implementations, the body components include a refuse packer driven by an electric packer actuator, and the operational sensor data indicates a position of the refuse packer.

In some implementations, the body components include powered tailgate driven by an electric tailgate actuator, and the operational sensor data indicates a position of the tailgate.

In some implementations, the body components include a lift arm driven by an electric lift arm motor, and the operational sensor data indicates a position of a lift arm. The lift arm is configured to lift a refuse container and empty the refuse container into the refuse storage compartment.

In some implementations, the battery charger includes a DC-DC converter.

In some implementations, controlling the battery charger includes controlling a rate of charge of the body battery.

In some implementations, the battery charger is configured to receive electricity from the chassis battery at a voltage of between 500V to 1000V and output electricity at a voltage of less than between 90V and 120V.

In some implementations, the body components are driven by electric motors powered by the body battery.

In some implementations, the vehicle includes a power distribution unit configured to receive electricity from the body battery and distribute the electricity to the body components.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Particular implementations of the subject matter described in this specification can be implemented so as to realize one or more of the following advantages. For example, the electric refuse collection vehicle of the present disclosure can be configured to utilize commercially available high power actuator motors and motor controllers that operate at different voltages from each other and at different voltages than a chassis battery supplying electric power to other systems, such as a vehicle propulsion system. The actuator motors can be powered from a body battery that is charged from the chassis battery.

The disclosed techniques can charge a body battery of a refuse collection vehicle from a chassis battery of the vehicle. Doing so can reduce the number of different charging ports needed for charging the refuse collection vehicle as a whole (e.g., providing a single point of charging between routes). For example, instead of separately charging the chassis battery and the body battery, the chassis battery alone can be charged at a single charging station. Then, during operation of the refuse collection vehicle (e.g., while the refuse collection vehicle is transiting to and from a pickup route and/or throughout the pickup route), the body battery can be charged from the chassis battery.

Additionally, the disclosed techniques can be implemented to control charging of the body battery to occur between pickup events performed by the refuse collection vehicle. Thus, simultaneously charging and discharging the body battery can be avoided, which may inhibit or even prevent overheating the body battery.

Charging of the body battery can be controlled to reduce a number of charge cycles of the body battery. For example, the body battery can operate until the charge level of the battery reaches a lower threshold charge level, at which time the body battery is charged to an upper threshold level. This reduces the number of charge cycles performed on the body battery, extending the overall lifetime of the battery.

Furthermore, the size the body battery can be reduced because the body battery does not need to power body components through an entire pickup route on a single charge. The body battery can be charged during the route by the chassis battery, as needed, to maintain sufficient charge on the body battery to power the body components. The size of the body battery can be reduced, for example, by a factor of one-half, one-third, or one-quarter, compared to a size of a body battery that is not chargeable during a route.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### BRIEF DESCRIPTION OF THE DRAWINGS

FIG. 1 is a side view of a refuse collection vehicle having a chassis battery and a body battery.

FIG. 2 is a block diagram of an example battery charging system for a refuse collection vehicle.

FIG. 3 is a diagram illustrating communication paths and electrical current paths of an example battery charging system for a refuse collection vehicle.

FIG. 4 is a flow chart of an example process for charging a battery of a refuse collection vehicle.

FIG. 5 is a schematic illustration of an example control system or controller of the refuse collection vehicle.

### DETAILED DESCRIPTION OF THE DISCLOSURE

The electric waste collection vehicle of the present disclosure includes electrical actuators that move the various body components of the vehicle. The electric waste collection vehicle of the present disclosure uses a battery charger that converts a high direct current (DC) battery voltage to a lower DC voltage selected for charging a body battery of the vehicle. The body battery provides power to the electrical actuators that drive the body components of the vehicle. The body battery can be charged during operation of the waste collection vehicle.

Charging of the body battery can be controlled to occur when the body components of the vehicle are in an idle state. An idle state can be a state in which the body components are not consuming electrical power. For example, an idle state can be a state in which the vehicle is not presently performing a refuse pickup, is not presently performing packing operations in a refuse container, is not presently performing ejecting operations from the refuse container, and is not performing another operation that causes body components to consume electrical power. In some cases, charging of the body battery can be controlled to occur when the body components are consuming an amount of electrical power that is below a threshold amount of electrical power.

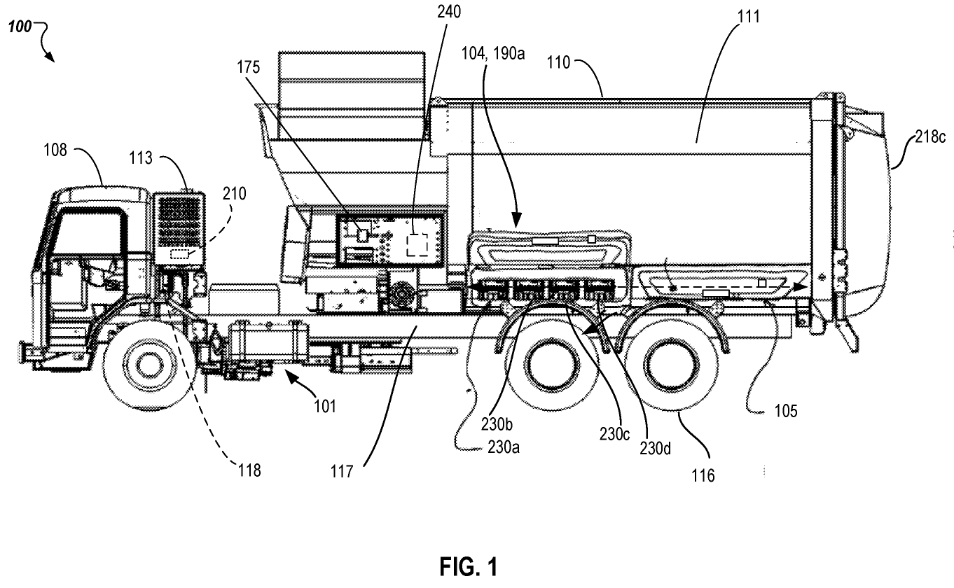

FIG. 1 depicts an example refuse collection vehicle 100 having a chassis battery and a body battery. The refuse collection vehicle 100 is illustrated as a side loader, but the refuse collection vehicle 100 can be a front loader, a rear loader, or another type of refuse collection vehicle such as a skid-loader, a tele-handler, a plow truck, or a boom lift.

The refuse collection vehicle 100 has a wheeled chassis 101. The wheeled chassis 101 includes a lower frame 117 and road wheels 116 attached to the lower frame 117. The refuse collection vehicle 100 also includes a cab 108 (e.g., a driver’s cab), a refuse collection body 110 carried by the wheeled chassis 101, and a tailgate 218c coupled to the body 110. Propulsion of the chassis 101 of the refuse collection vehicle 100 is powered by an electric engine. The refuse collection body 110 has an interior volume. The interior volume 109 includes a refuse storage compartment 111 that receives and stores refuse collected by the refuse collection vehicle 100. In addition, the interior volume includes battery compartments 104, 105.

The refuse collection vehicle 100 can be fully electric. For example, the refuse collection vehicle 100 can have electric actuators (instead of hydraulic actuators) and one or more electric propulsion motors 118 connected to one or more wheels 116 of the chassis 101. The electric propulsion motors 118 can be configured, for example and without limitation, as hub motors, belt-drive motors, or mid-drive motors. The electric propulsion motors 118 can be, for example and without limitation, DC series motor, brushless DC motors, permanent magnet synchronous motors (PMSM), AC induction motors (e.g., three-phase AC induction motors), or switched reluctance motors (SRM). One or more battery packs can form a chassis battery 210 that powers the propulsion motors 118.

The refuse collection vehicle 100 can include a battery housing 113 that stores a chassis battery 210. The chassis battery 210 can include multiple battery cells (e.g., lithium-ion battery cells) that provide electrical power to the electric propulsion motors 118, to the electronic components of the chassis (e.g., headlights and taillights) and to the electric components of the cab 108 (e.g., interior lights, navigation, air conditioning, radio, etc.).

The refuse collection vehicle 100 includes battery compartments 104, 105 for receiving one or more body battery cells 230a-d (collectively referred to as body battery 230) that can be used to power one or more components of the refuse collection body 110. The refuse collection vehicle 100 can also include other components associated with electric vehicles such as a body battery charger, an inverter, sensors, switches, and control systems such as an electric vehicle monitoring system (EVMS) and a battery management system (BMS).

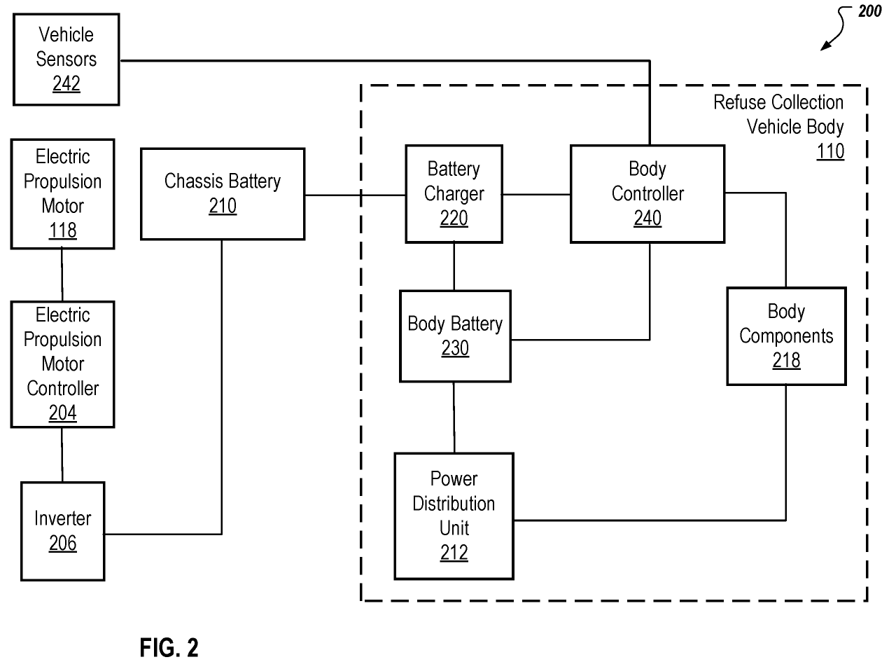

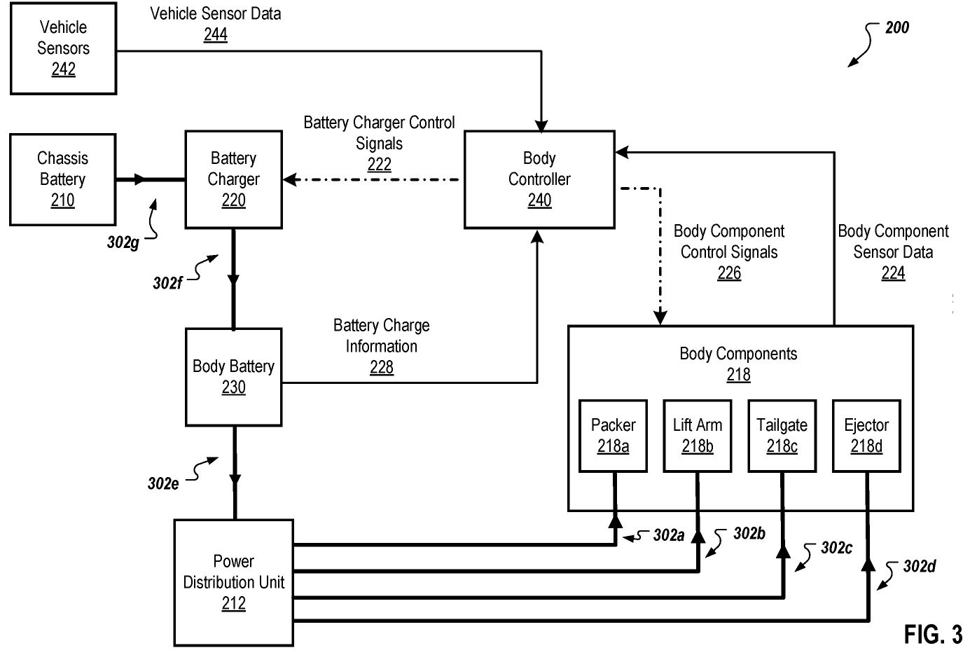

The refuse collection body 110 includes body components (e.g., body components 218 shown in FIGS. 2 and 3) that can be driven by electric actuators and/or motors. Body components can include, for example, a refuse packer 218a, a lift arm 218b, a tailgate 218c, and an ejector 218d. For example, the refuse collection vehicle 100 can have ejector electric actuators, body-raise electric actuators, container lift actuators, tailgate electric actuators, packer electric actuators, or any combination of these.

The tailgate 218c can be opened to permit entry of refuse into the refuse storage compartment 111 or to permit egress of refuse from the refuse storage compartment 111. The refuse packer 218a can be extended to pack refuse within the refuse storage compartment 111 and can be retracted to a stowed position. The lift arm 218b can be extended to engage with a refuse container, can be raised to lift the refuse container and dump the refuse container into the refuse storage compartment 111, can be lowered to return the refuse container to the ground, and can be retracted to a stowed position. The lift arm 218b can be a side lift arm for a side-loader refuse collection vehicle or can be a front lift arm for a front-loader refuse collection vehicle. The ejector 218d can be extended to push refuse out of the refuse storage compartment 111 and can be retracted to a stowed position.

In some implementations, some of the body actuation functions can be electric and some of the body actuation functions can remain hydraulic. For example, instead of being driven by electric actuators, the tailgate 218c can be moved by hydraulic actuators. This could be accomplished with a local oil reservoir or with a larger oil reservoir that serves multiple hydraulic actuation points. In some examples, the tailgate 218c can be driven by electro-hydraulic actuator assemblies. An electro-hydraulic actuator assembly includes an actuator in which electricity powers a motor to drive a pump that pressurizes hydraulic fluid of the actuator. In some examples, the motor of the electro-hydraulic actuator assembly can be electrically powered by a battery. For example, a separate tailgate battery (such as a 12V battery) can be positioned near a tailgate actuator and electrically connected to the tailgate actuator assembly to power a motor and pump the tailgate actuator assembly, which controls the hydraulic pressure of the tailgate actuator(s). In some examples, the tailgate battery has a dedicated charger that pulls from the vehicle’s electrical system (e.g., the vehicle’s 12V system). In some examples, the tailgate battery can be charged by the body battery 230. For example, the tailgate battery can be one of the body components 218 powered by the body battery 230.

The battery cells of the body battery 230 in the battery compartments 104, 105, can be used to power various loads, such as body components 218 of the refuse collection vehicle 100. The body components 218 including, but are not limited to, electric actuators of the refuse collection body 110. In some implementations, each of the battery cells of the battery 230 is electrically coupled to a power distribution unit (e.g., power distribution unit 212 shown in FIG. 2), and the power distribution unit 212 distributes the power output by the body battery 230 to one or more body components 218 of the body 110 of the refuse collection vehicle 100. In some implementations, the body controller 240 includes a BMS that can be used to manage and monitor battery function and safety controls of the body battery 230 within the battery compartments 104, 105.

FIG. 2 is a block diagram of an example battery charging system 200 for a refuse collection vehicle. The system 200 includes the chassis battery 210, a battery charger 220, the body battery 230, and the body controller 240. In some examples, the battery charger 220, the body battery 230, the body controller 240, the power distribution unit 212, and/or the body components 218 are integrated with the refuse collection vehicle body 110. In some examples, the battery charger 220, the body battery 230, the body controller 240, the power distribution unit 212, and/or the body components 218 are mounted to the chassis 101.

The chassis battery 210 is electrically connected and provides power to the electric propulsion motor 202. An inverter 206 can be used when the electric propulsion motor 202 is an alternating current (AC) motor. The inverter 206 receives DC electricity from the chassis battery 210 and outputs AC electricity to the electric propulsion motor 202. If the electric propulsion motor 202 is a DC motor, the battery pack can directly transmit electricity to the electric propulsion motor controller 204 without the inverter 206.

The body battery 230 is configured to provide electrical power to the body components 218. The body battery 230 is electrically connected to and provides power to electric motors associated with the electric actuators of the refuse collection body.

The battery charger 220 is electrically connected to the chassis battery 210 and is configured to charge the body battery 230 from the chassis battery 210. In some examples, the battery charger 220 is a single device that converts electrical energy and directly charges the body battery 230. In some examples, the battery charger 220 includes multiple components. For example, the battery charger 220 can include a converter and a charging unit. Electrical energy output by the converter can provide power to the charging unit, which can charge the body battery 230.

In some examples, the battery charger 220 includes a DC-DC converter. The battery charger 220 can lower the voltage of the electricity received from the chassis battery 210 and transmit the electricity at a lower voltage to the body battery 230. For example, the battery charger can receive electricity from the chassis battery 210 at a voltage of between 500V to 1000V and output electricity at a voltage between 90V and 120V. In some examples, the battery charger 220 includes a DC-AC converter. The generated AC voltage can be used to charge the body battery 230 directly or to power a separate unit that is configured to charge the body battery 230.

The body battery 230 provides power to the power distribution unit 212. The power distribution unit 212 distributes the power to the multiple controllers which control electric motors of the body components 218.

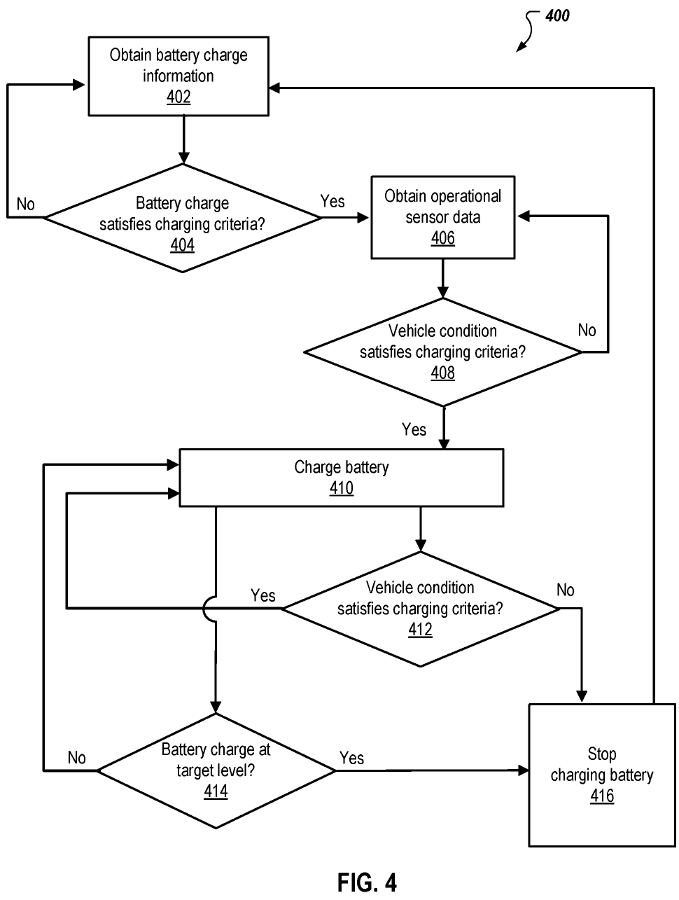

The body controller 240 controls the battery charger 220 to charge the body battery 230 from the chassis battery 210. The body controller 240 can receive input from the body battery 230, the battery charger 220, vehicle sensors 242, the body components 218, or any combination thereof. The body controller 240 can control a start time and stop time of charging the body battery 230. In some examples, the body controller 240 controls a rate of charge of the body battery 230. For example, while charging the body battery 230, the body controller 240 can decrease the rate of charge of the body battery 230 as the charge level rises and approaches a maximum threshold (e.g., 100% charge). The body controller 240 can increase the rate of charge of the body battery 230 when the charge is at a lower charge level. Operations of the body controller 240 are described in greater detail with reference to FIGS. 3 and 4.

FIG. 3 shows communication paths and electrical current paths 302 between components of the example battery charging system 200 for a refuse collection vehicle. An electrical current path can include a conductive path for electrical current such as a wire or cable. The electrical current paths 302 include currents paths 302a-d from the power distribution unit 212 to the body components 218. For example, the electrical current paths 302 include current path 302a from the power distribution unit 212 to the packer 218a, current path 302b from the power distribution unit 212 to the lift arm 218b, current path 302c from the power distribution unit 212 to the tailgate 218c, and current path 302d from the power distribution unit 212 to the ejector 218d.

The power distribution unit 212 receives electrical power from the body battery 230 through current path 302e. The body battery 230 is charged by the battery charger 220 through current path 302f. The battery charger 220 charges the body battery 230 with electrical power obtained from the chassis battery 210 through current path 302g.

The body controller 240 can control operations of the battery charger 220 and the body components 218 by generating and outputting battery charger control signals 222 and body component control signals 226.

As described above, the body controller 240 can receive input from the body battery 230, the battery charger 220, vehicle sensors 242, the body components 218, or any combination thereof. The body controller 240 can receive vehicle sensor data 244 from the vehicle sensors 242 and body component sensor data 224 from sensors of the body components 218. The vehicle sensor data 244 and the body component sensor data 224 can collectively be referred to as “operational sensor data.”

The vehicle sensor data 224 can generated by the vehicle sensors 242. The vehicle sensors 242 can include, for example, a vehicle speed sensor, a location sensor, an accelerometer, or any combination thereof. The vehicle sensor data 244 can include a vehicle location, vehicle speed, vehicle acceleration, or any combination thereof.

The body components 218 include a packer 218a, a lift arm 218b, a tailgate 218c, and an ejector 218d. The body component sensor data 224 is generated by sensors of the body components 218. The body component sensor data 224 can include sensor data indicating a status (e.g., position and/or movement) of the packer 218a, the lift arm 218b, the tailgate 218c, and/or the ejector 218d.

The body controller 240 can receive battery charge information 228 from the body battery 230. The battery charge information 228 can include a state of charge of the body battery 230 represented as a percentage. In some examples, the battery charge information 228 includes a present status of the body battery 230. For example, the battery charge information 228 can indicate that the body battery 230 is presently charging or is presently discharging. The battery charge information 228 can indicate a present rate of charge of the body battery 230 and/or a present rate of discharge of the body battery 230. The battery charge information 228 can include a measure of electric current flowing to the body battery 230 and/or a measure of electric current being drawn from the body battery 230.

The body controller 240 can send the battery charger control signals 222 to the battery charger 220 to control operations of the battery charger 220. The battery charger control signals 222 can cause the battery charger 220 to initiate charging the body battery 230. The battery charger control signals 222 can cause the battery charger 220 to stop charging the body battery 230. The battery charger control signals 222 can adjust a rate of charging the body battery 230. In some examples, the battery charger control signals 222 specify a rate of charging of the body battery (e.g., 64 Amps). In some examples, the battery charger control signals 226 cause an increase or decrease in a rate of charging the body battery 230.

In some examples, the body controller 240 controls the battery charger 220 to charge the body battery 230 between pickup events performed by the refuse collection vehicle. The body controller 240 can monitor the operational sensor data (e.g., vehicle sensor data 244 and/or body component sensor data 224) to determine when pickup events occur. A pickup event is an event in which the refuse collection vehicle picks up a refuse container or refuse object (e.g., with a lift arm) and lifts the container in order to dump contents of the container into the storage compartment of the refuse collection vehicle. During an example pickup event, the refuse collection vehicle decelerates, extends the lift arm, engages the lift arm with the refuse container, lifts the refuse container off the ground using the lift arm, empties the refuse container into the storage compartment, lowers the refuse container to the ground using the lift arm, disengages the lift arm from the refuse container, retracts the lift arm, and accelerates to transit to the next refuse pickup event. The body controller 240 can control the battery charger 220 to charge the body battery 230 in response to detecting retraction of the lift arm, acceleration above a threshold speed, or both, such that the body battery 230 is charged while the refuse collection vehicle is in transit to the next refuse pickup event.

In some examples, the refuse packer 218a operates for a period of time after a pickup event. For example, the refuse packer 218a may operate for approximately fifteen to thirty seconds following a pickup event. In some cases, the refuse collection vehicle 100 performs multiple pickup events consecutively, such that the refuse packer 218a may run continuously or near continuously. The body controller 240 can control the battery charger 220 to charge the body battery 230 in response to detecting that the packer has been stationary for at least a threshold time duration, such that the body battery 230 is charged after the refuse collection vehicle completes a cluster of refuse pickup events and before the refuse collection vehicle begins a next refuse pickup event or cluster of events. For example, the body battery 230 can be charged while the vehicle is in transit to a new block or neighborhood.

In some examples, the body controller 240 can adjust operations of the body components 218 in order to prioritize charging of the body battery 230. For example, when the body battery 230 has a state of charge that is below a threshold state of charge (e.g., such that the battery state of charge is critically low), The body controller 240 can adjust operations of the body components 218 to increase the amount of time available for charging the body battery 230. The operations of the body components 218 can be adjusted, for example, by shortening the amount of time of operation of the refuse packer 218a, by reducing the frequency of operation of the refuse packer 218a, or both.

The body controller 240 can determine when a pickup event is occurring or is about to occur based on analyzing the vehicle sensor data 244 and/or the body component sensor data 224 to monitor vehicle conditions such as vehicle speed and lift arm position. The body controller 240 can determine to initiate charging the body battery 230 after completion of a refuse pickup event. The body controller 240 can determine to stop charging the body battery 230 prior to a next refuse pickup event, or in response to detecting initiation of the next refuse pickup event. Body controller 240 operations to control charging of the body battery 230 between refuse pickup events are described in greater detail with reference to FIG. 4.

The body controller 240 can send body component control signals 226 to the body components 218. The body component control signals 226 can cause movement of the body components 218. In some examples, the body component control signals 226 control one or more electrical switches that control the flow of electricity from the power distribution unit 212 to the body components 218. In some examples, the body component control signals 226 control one or more actuators associated with the body components 218. For example, the body component control signals 226 can control a packer actuator to cause the packer 218a to extend or retract. The body component control signals 226 can control a lift arm actuator to cause the lift arm 218b to raise or lower. The body component control signals 226 can control a tailgate actuator to cause the tailgate 218c to raise or lower (or open or shut). The body component control signals 226 can control an ejector actuator to cause the ejector 218d to extend or retract.

FIG. 4 is a flow chart of an example process 400 for charging a battery of a refuse collection vehicle. The process 400 can be performed by one or more control systems and/or one or more controllers, such as the body controller 240 or a BMS.

The process 400 includes obtaining a battery charge information for a body battery (402). The battery charge information can include, for example, a state of charge of the body battery 230 as represented by a percentage, a charge or discharge status of the body battery 230, a rate of charge or discharge of the body battery 230, or any combination thereof.

The process 400 includes determining whether the battery charge satisfies charging criteria (404). The charging criteria can include a threshold battery charge level such as a minimum threshold charge level (e.g. 20%). By not charging the body battery 230 unless the charge level is less than the minimum threshold charge level, the number of charge cycles performed on the body battery 230 can be reduced, extending the overall lifetime of the battery.

The charging criteria can include a threshold discharge rate for the body battery 230. For example, the charging criteria can include an electric current drawn or discharged from the body battery 230 being at or below a threshold electric current. By not charging the body battery 230 unless the discharge current is at or below a threshold current, simultaneous charging and discharging can be prevented in order to avoid overheating of a battery.

The process 400 includes, in response to determining that the battery charge does not satisfy charging criteria, continuing to monitor the body battery by obtaining the battery charge information (402). For example, the body controller 240 can determine that the body battery charge level is above the minimum threshold charge level (e.g., >20%) and can therefore continue to monitor the battery charge level. In another example, the body controller 240 can determine that an electrical current drawn from the body battery 230 is greater than a threshold electric current and can therefore continue to monitor the battery discharge rate.

The process 400 includes, in response to determining that the battery charge satisfies the charging criteria, obtaining operational sensor data (406). For example, the body controller 240 can determine that the battery charge level is at or below the minimum threshold charge level (e.g., ≤20%), and in response, obtain operational sensor data to monitor for vehicle conditions that are suitable for charging the body battery. Operational sensor data can include, for example, data indicating vehicle speed, vehicle location, a position of a refuse packer, a position of a lift arm, a position of a tailgate, a position of an ejector, or any combination of these.

The process 400 includes determining whether a vehicle condition satisfies charging criteria (408). Charging criteria can include indications that the vehicle being in between refuse pickup events. For example, the body controller 240 can determine, based on operational sensor data, that the vehicle is not in progress of performing a refuse pickup event and/or that the vehicle is between refuse pickup events, and therefore determine that the vehicle condition satisfies charging criteria. In another example, the body controller 240 can determine, based on operational sensor data, that the vehicle is in progress of performing a refuse pickup event, and therefore determine that the vehicle condition does not satisfy the charging criteria.

Indications of the vehicle being between pickup events can include, for example, a vehicle speed being greater than a threshold speed, an acceleration being greater than a threshold acceleration, a lift arm being in a stowed position, a lift arm being unmoving for at least a threshold time duration, a packer being in an unextended position, the tailgate being shut, or any combination of these.

In an example, the body controller 240 can determine that the vehicle is between pickup events in response to determining that the vehicle speed is greater than a threshold speed (e.g., 5mph) and that the lift arm is unmoving for at least a threshold time duration (e.g., three seconds). In another example, the body controller 240 can determine that the vehicle is between pickup events in response to determining that the vehicle speed is greater than a threshold speed (e.g., 5pm) and that the vehicle acceleration is greater than a threshold acceleration (e.g., 2ft/s²). In some examples, the body controller 240 determines a confidence that the vehicle is between pickup events based on the operational sensor data, and the battery charging criteria includes a threshold confidence of the vehicle being in between pickup events (e.g., a minimum confidence of 70%). For example, the body controller 240 can determine, based on the operational sensor data, that there is an 80% confidence that the vehicle is not currently performing a pickup event. In response to determining that the 80% confidence is greater than the threshold confidence of 70%, the body controller 240 can determine that the vehicle condition satisfies charging criteria.

Indications of the vehicle presently performing a pickup event can include, for example, the vehicle speed being less than the threshold speed, the lift arm being in an extended or raised position, the packer being in an extended position, the tailgate being open, or any combination of these. In an example, the body controller 240 can determine that the vehicle is conducting a pickup event in response to determining that the vehicle speed is less than a threshold speed (e.g., 5mph) and that the lift arm is moving. In another example, the body controller 240 can determine that the vehicle is between pickup events in response to determining that the vehicle speed is less than a threshold speed (e.g., 5pm) and that the tailgate 218c is open.

The process includes, in response to determining that the vehicle condition does not satisfy the charging criteria, continuing to monitor the vehicle condition by obtaining operational sensor data (406). For example, in response to determining that the vehicle is in process of performing a refuse pickup event, the body controller 240 can continue to monitor the operational sensor data for vehicle conditions that are suitable for charging the body battery. Vehicle conditions that are suitable for charging the body battery can include vehicle conditions that indicate that the pickup event has ended and that the next pickup event has not yet begun.

Although FIG. 4 shows the battery charge criteria being evaluated (404) prior to the vehicle condition charge criteria (408), other sequences are possible. For example, in some cases the body controller 240 can monitor the operational sensor data to identify vehicle conditions that are suitable for charging and then use the body battery charge information to determine whether battery charging criteria is satisfied. In some examples, the body controller 240 simultaneously or concurrently evaluates the operational sensor data and the body battery charge information to determine when to charge the body battery.

The process 400 includes, in response to determining that the vehicle condition satisfies the charging criteria, charging the battery (410). For example, in response to determining that the vehicle is in between refuse pickup events, the body controller 240 can initiate charging the body battery 230 from the chassis battery 210 using the battery charger 220.

The process 400 includes, while charging the battery, determining whether a vehicle condition satisfies charging criteria (412). For example, while charging the battery, the body controller 240 can obtain updated operational sensor data indicating an updated condition of the refuse collection vehicle. The body controller 240 can continue to monitor vehicle conditions using the updated operational sensor data. The body controller 240 can determine, using the operational sensor data, when a next refuse pickup event is beginning.

The process 400 includes, in response to determining that the vehicle condition satisfies the charging criteria, continuing to charge the battery (410). For example, while the operational sensor data indicates that the body of the vehicle is in an idle state (e.g., a state in which the body of the vehicle is not performing a refuse pickup event, packing event, ejecting event, or another event that causes the body components to consume electrical power), the body controller 240 can continue to charge the body battery 230.

The process 400 includes, in response to determining that the vehicle condition does not satisfy the charging criteria, stopping charging of the battery (416). For example, when the operational sensor data indicates that the vehicle is performing or about to perform a refuse pickup event, the body controller 240 can stop charging the body battery 230. The vehicle condition not satisfying the charging criteria can include, for example, the vehicle speed dropping below a threshold speed, the packer being in an extended position, the lift arm moving out of the stowed position, the tailgate opening, or any combination of these.

The process 400 includes, while charging the battery, determining whether the battery charge is at a target level (414). For example, the body controller 240 can obtain updated battery charge information and determine whether the battery has been sufficiently charged. The target level can be, for example, a threshold battery charge level represented by a percentage (e.g., 85%, 90%, 100%).

The process 400 includes, in response to determining that the battery is not at the target level, continuing to charge the battery (410). For example, the body controller 240 can determine that the battery charge level is below the target level and can therefore continue to charge the body battery 230 until the body battery charge reaches the target level.

The process 400 includes, in response to determining that the battery is at or above the target level, stopping charging of the battery (416). For example, the body controller 240 can determine that the battery charge level is at or above the target level and can therefore stop charging the body battery 230.

The process 400 includes, after stopping charging of the battery (416), continuing to monitor the battery by obtaining the battery charge information (402). For example, after the body battery 230 is charged to the target level, the body controller 240 can continue to monitor the battery charge level of the body battery 230 to determine when to initiate charging of the body battery 230 again.

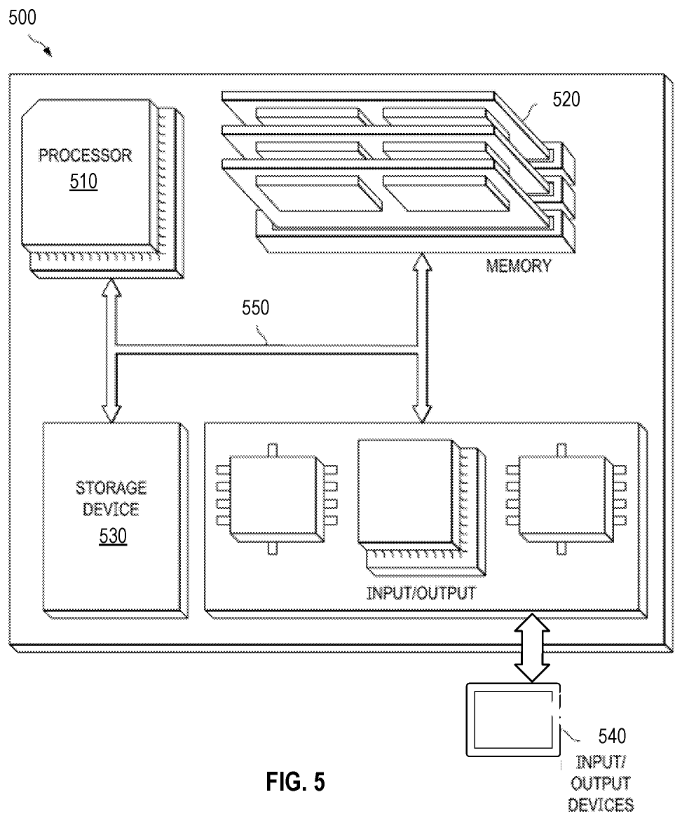

FIG. 5 is a schematic illustration of an example control system or controller for a waste collection vehicle according to the present disclosure. For example, the controller 500 may include or be part of the body controller 240 shown in FIGS. 2 and 3. The controller 500 is intended to include various forms of digital computers, such as printed circuit boards (PCB), processors, digital circuitry, or otherwise. Additionally, the system can include portable storage media, such as Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output device 540. Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the controller 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output device 540 provides input/output operations for the controller 500. In one implementation, the input/output device 540 includes a keyboard and/or pointing device. In another implementation, the input/output device 540 includes a display unit for displaying graphical user interfaces.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms "a", "an", and "the" include plural referents, unless the context clearly dictates otherwise.

As used in the present disclosure and in the appended claims, the words "comprise," "has," and "include" and all grammatical variations thereof are each intended to have an open, non-limiting meaning that does not exclude additional elements or steps.

As used in the present disclosure, terms such as "first" and "second" are arbitrarily assigned and are merely intended to differentiate between two or more components of an apparatus. It is to be understood that the words "first" and "second" serve no other purpose and are not part of the name or description of the component, nor do they necessarily define a relative location or position of the component. Furthermore, it is to be understood that that the mere use of the term "first" and "second" does not require that there be any "third" component, although that possibility is contemplated under the scope of the present disclosure.

What is claimed is:

1. A refuse collection vehicle, comprising:
a wheeled chassis with an electric propulsion motor connected to a road wheel of the chassis;
a chassis battery configured to provide electrical power to the electric propulsion motor;
a refuse collection body carried by the wheeled chassis and defining a refuse storage compartment, the refuse collection body comprising one or more body components;
a body battery configured to provide electrical power to the one or more body components;
a battery charger connected to the chassis battery and configured to charge the body battery from the chassis battery; and
at least one processor configured to perform operations comprising controlling the battery charger to charge the body battery from the chassis battery when one or more body battery charging criteria are satisfied.

2. The refuse collection vehicle of claim 1, wherein charging the body battery from the chassis battery when one or more body battery charging criteria are satisfied comprises charging the body battery in between refuse pickup events performed by the vehicle.

3. The refuse collection vehicle of claim 1, wherein charging the body battery from the chassis battery when the one or more body battery charging criteria are satisfied comprises charging the body battery when electric current drawn from the body battery is at or below a threshold electric current.

4. The refuse collection vehicle of claim 1, wherein controlling the battery charger to charge the body battery from the chassis battery when the one or more body battery charging criteria are satisfied comprises:
obtaining a battery charge level of the body battery;
determining that the battery charge level of the body battery satisfies first battery charging criteria;
obtaining operational sensor data indicating a condition of the refuse collection vehicle;
determining, based on the operational sensor data, that the condition of the refuse collection vehicle satisfies second battery charging criteria; and
in response to determining that (i) the battery charge level of the body battery satisfies the first battery charging criteria and (ii) the condition of the refuse collection vehicle satisfies the second battery charging criteria, initiating charging of the body battery from the chassis battery.

5. The refuse collection vehicle of claim 4, the operations comprising:
after initiating charging the body battery, determining that a refuse pickup event is beginning, and in response, stopping charging of the body battery.

6. The refuse collection vehicle of claim 4, wherein the first battery charging criteria comprises a threshold battery charge level.

7. The refuse collection vehicle of claim 4, wherein the operational sensor data comprises sensor data indicating a speed of the refuse collection vehicle, and the second battery charging criteria comprises a threshold vehicle speed.

8. The refuse collection vehicle of claim 4, wherein:
the operational sensor data comprises sensor data indicating an operational state of the one or more body components;
the one or more body components comprise at least one of a lift arm or a refuse packer; and
the second battery charging criteria comprise at least one of a position of the lift arm or a position of the refuse packer.

9. The refuse collection vehicle of claim 4, wherein:
the body components comprise at least one of a refuse packer driven by an electric packer actuator, a powered tailgate driven by an electric tailgate actuator, or a lift arm driven by an electric lift arm motor; and
the operational sensor data indicates at least one of a position of the refuse packer, a position of the tailgate, or a position of the lift arm.

10. The refuse collection vehicle of claim 1, wherein:
the battery charger comprises a DC-DC converter; and
controlling the battery charger comprises controlling a rate of charge of the body battery.

11. The refuse collection vehicle of claim 1, wherein the body components are driven by electric motors powered by the body battery.

12. The refuse collection vehicle of claim 1, wherein the vehicle further comprises a power distribution unit configured to receive electricity from the body battery and distribute the electricity to the body components.

13. A method of operating a refuse collection vehicle, comprising:
controlling, by at least one processor, a battery charger to charge a body battery of the refuse collection vehicle from a chassis battery of the refuse collection vehicle when one or more body battery charging criteria are satisfied, wherein:
the chassis battery is configured to provide electrical power to an electric propulsion motor connected to a road wheel of a chassis of the refuse collection vehicle, and
the body battery is configured to provide electrical power to one or more body components of a refuse collection body that defines a refuse storage compartment and is carried by the chassis.

14. The method of claim 13, wherein charging the body battery from the chassis battery when one or more body battery charging criteria are satisfied comprises charging the body battery in between refuse pickup events performed by the vehicle.

15. The method of claim 13, wherein charging the body battery from the chassis battery when the one or more body battery charging criteria are satisfied comprises charging the body battery when electric current drawn from the body battery is at or below a threshold electric current.

16. The method of claim 13, wherein controlling the battery charger to charge the body battery from the chassis battery when the one or more body battery charging criteria are satisfied comprises:
obtaining a battery charge level of the body battery;
determining that the battery charge level of the body battery satisfies first battery charging criteria;
obtaining operational sensor data indicating a condition of the refuse collection vehicle;
determining, based on the operational sensor data, that the condition of the refuse collection vehicle satisfies second battery charging criteria; and
in response to determining that (i) the battery charge level of the body battery satisfies the first battery charging criteria and (ii) the condition of the refuse collection vehicle satisfies the second battery charging criteria, initiating charging of the body battery from the chassis battery.

17. The method of claim 16, comprising:
after initiating charging the body battery, determining that a refuse pickup event is beginning; and
in response, stopping charging of the body battery.

18. The method of claim 16, wherein controlling the battery charger to charge the body battery from the chassis battery comprises:
after initiating charging of the body battery from the chassis battery, determining that the battery charge level of the body battery satisfies stop criteria for stopping charging of the body battery; and
in response, stopping charging of the body battery from the chassis battery, wherein the stop criteria includes the battery charge level being at or above a threshold charge level.

19. The method of claim 16, comprising:
determining, using the operational sensor data, that a refuse pickup event has been completed, and in response, initiating charging the body battery.

20. The method of claim 16, wherein controlling the battery charger to charge the body battery from the chassis battery comprises:
after initiating charging of the body battery from the chassis battery, obtaining updated operational sensor data indicating an updated condition of the refuse collection vehicle;
determining, based on the updated operational sensor data, that the updated condition of the refuse collection vehicle does not satisfy the second battery charging criteria; and
in response, stopping charging of the body battery from the chassis battery.
